(19) United States
(12) Patent Application Publication
(10) Pub. No.: US 2007/0119819 A1
(43) Pub. Date: May 31, 2007

(54) Axial current interrupter

(76) Inventors: Thangavelu Asokan, Bangalore (IN); Bansidhar Jagannath Phansalkar, Bangalore (IN); John Charles Hill JR., Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/289,933

(22) Filed: Nov. 30, 2005

(51) Int. Cl. H01H 33/76

(52) U.S. Cl. 218/90

(57) ABSTRACT

An apparatus (e.g., 12) for interrupting an electrical current between two contacts includes a first contact (12) and a second contact (16). The first and second contacts are separable away from one another to interrupt an electrical current flowing between the contacts. An arc constrictive zone (20) may be disposed around the contacts confining an arc (32) generated between the contacts during a separation of the contacts. An ablative material (28) may be disposed in the arc restrictive zone to be ablated by the arc to form a vapor for cooling the arc and producing an increased pressure in the restrictive zone responsive to the arc to force separation of the contacts.

### FIELD OF THE INVENTION

Embodiments of the present invention are generally related to circuit arc quenching, or current interruption, devices, and, more particularly, to an axial circuit arc quenching, or current interrupter, including an arc constrictive zone.

### BACKGROUND OF THE INVENTION

A variety of devices are known and have been developed for interrupting current between a source and a load. Circuit breakers are one type of device designed to trip upon occurrence of heating or over-current conditions. Other circuit interrupters trip either automatically or by implementation of a tripping algorithm, such as to limit current to desired levels, limit power through the device in the event of phase loss or a ground fault condition. In general, such devices include one or more moveable contacts, which separate from mating contacts to interrupt a current carrying path. The devices may be single phase or include multiple phase sections for interrupting current through parallel current paths, such as in three phase applications.

Performance of a circuit interrupter is typically dictated by a peak let through current, which is in turn controlled by a rate of arc voltage development across the contacts as the contacts are moved away from one another during a circuit interruption event. Accordingly, improvement of circuit interrupter performance has focused on more rapidly increasing arc voltage development to limit a peak let though current. A wide range of techniques has been employed for improving interruption times to limit the let-through energy, such as by providing faster contact separation. The voltage investment in an arc may be made to rise very quickly to cause a corresponding rapid interruption of the current. Another technique used to limit the let-through energy is to provide arc dissipating structures, such as conductive plates arranged with air gaps between each plate, commonly known as an arc chute. Entry of the arc into such structures may assist in extinguishing the arc and thereby limit the let-through energy during circuit interruption.

### BRIEF DESCRIPTION OF THE DRAWINGS

FIG. 1 shows a partial cross sectional schematic view of an example embodiment of a circuit interrupter in a current conducting mode.

FIG. 2 shows a partial cross sectional schematic view of the example embodiment of the circuit interrupter of FIG. 1 at a beginning of a current interruption mode.

FIG. 3 shows a partial cross sectional schematic view of the example embodiment of the circuit interrupter of FIG. 1 at an end of a current interruption mode.

FIG. 3A shows a partial cross sectional schematic view of another example embodiment of the circuit interrupter of FIG. 1.

FIG. 3B shows a partial cross sectional schematic view of another example embodiment of the circuit interrupter of FIG. 1.

FIG. 4 shows another example embodiment of a circuit interrupter.

FIG. 5 shows another example embodiment of a circuit interrupter.

FIG. 6 shows another example embodiment of a circuit interrupter including an enclosure.

FIG. 7 shows an example circuit breaker including an example embodiment of a circuit interrupter.

FIG. 7A shows an example three phase circuit breaker including an example embodiment of a circuit interrupter.

FIG. 8 is a graph showing circuit interruption performance for the example circuit interrupter of FIG. 1.

FIG. 9 is a graph showing circuit interruption performance for an example conventional-type circuit interrupter that does not include an arc constrictive zone.

### DETAILED DESCRIPTION OF THE INVENTION

The inventors of the present invention have innovatively realized that a portion of the energy in an arc produced in a circuit interrupter may be harnessed to provide a force acting to separate contacts of the circuit interrupter, thereby providing faster contact separation and correspondingly faster arc voltage development resulting in improved circuit interruption performance compared to conventional circuit interrupters. By confining the arc to an arc constriction zone between the contacts and disposing an ablative material in the zone, an arc voltage development rate has been demonstrated to be increased compared to that of a circuit interrupter having no constrictive zone, resulting in a lower peak let through current. In another advantageous aspect of the invention, an ablation-formed vapor, generated as a result of the arc interacting with the ablative material, acts to cool the arc, resulting in a cooler gas emission and improved performance of the interrupter.

FIG. 1 shows a partial cross sectional schematic view of an example embodiment of an improved axial circuit interrupter 10 in a current conducting mode. The circuit interrupter 10 may include a first conducting element, or first contact 12, having a contacting end portion 14, and a second conducting element, or second contact 16, having a respective contacting end portion 18. When the contacts 12, 16 are positioned in electrical contact with one another, such as when the contacting end portions are abutting, an electrical current may be conducted between the elements 12, 16. The first 12 and second contacts 16 may be separable away from one another to interrupt an electrical current flowing between them. For example, the second contact 16 may be movable out of electrical contact with the first contact 12 to interrupt the electrical current, the first contact 12 may be movable out of electrical contact with the second contact 16 to interrupt the electrical current, or both contacts 12, 16 may be movable out of electrical contact with each other to interrupt the electrical current.

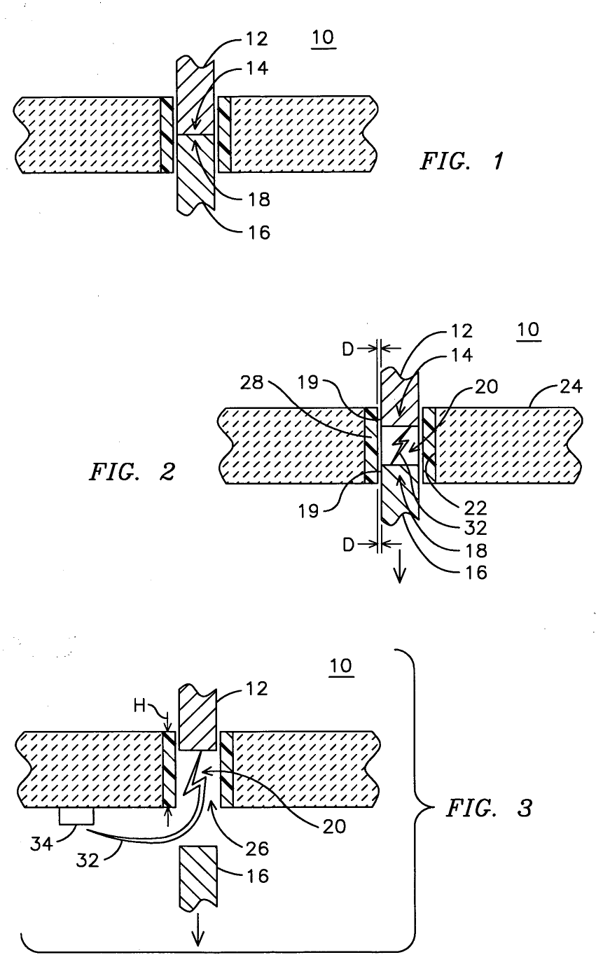

In an aspect of the invention shown in FIG. 2, the circuit interrupter 10 includes an arc constrictive zone 20 disposed around the contacts 12, 16, such as around respective end portions 14, 18 of the contacts 12, 16. The arc constrictive zone 20 may confine an arc 32 generated between the contacts 12, 16 during a separation of the contacts 12, 16, such as occurs at a beginning of a current interruption mode of the circuit interrupter. The arc constrictive zone 20 may be defined by wall 22 of an aperture 26 (as shown in FIG. 3) formed in an insulator 24, such as, but not limited to, a ceramic plate a polymer plate, a plastic composite plate or combination of these material, disposed around the around the contacts 12, 16. The constrictive zone 20 receives at least the end portions 14, 18 of the contacts 12, 16 when the contacts 12, 16 are positioned in electrical contact so that end portions 14, 18 remain within the constrictive zone 20 during at least an initial period of a current interruption mode. It should be understood that an arc created between the contacts 12, 16 is not limited to being located within the constrictive zone 20, and may extend outside of the zone 20, such as when one or more of the contacts 12, 16 are moved out of the constrictive zone 20, as shown in FIG. 3

Referring now to FIG. 3, a geometry of the aperture 26 may be selected to conform to a geometry of the contacts 12, 16. For example, a cylindrical aperture defining the constrictive zone 20 may be used for cylindrical contacts operating reciprocally with respect to constrictive zone 20. It should be understood that other geometries may be used, such as a square geometry, a rectangular geometry, a triangular geometry, or any other desired geometrical shape. In an aspect of the invention, a height, H, of the constrictive zone 20 may range from about 1 to about 24 millimeters (mm), and preferably from about 3 to about 10 mm, and even more preferably, from about 5 to about 7 mm. In an example embodiment shown in FIG. 3A, respective opening portions 27, 29 of the aperture 26 may be curved or tapered away from a central region 31 of the aperture 26. The aperture 26 may be defined by a single insulating layer 24, or, in another example embodiment shown in FIG. 3B, the aperture 26 may be defined by two or more spaced apart layers, such as multiple spaced apart insulators 24.

Returning to FIG. 2, an ablative material 28 may be disposed in the arc restrictive zone 20 for producing an increased pressure in the arc constrictive zone 20 forcing separation of the contacts 12, 16. The increased pressure may be generated in response to the arc 32 formed between the contacts 12, 16. When the contacts 12, 16 are initially separated from being in electrical contact as shown in FIG. 2, an arc 32 formed in the constrictive zone 20 there between generates vapors in the constrictive zone in part by the heat and/or radiation generated by the arc 32 acting on the ablative material 28 lining the walls 22. The vapor generated by the ablating process in turn causes a pressure increase in the constrictive zone 20 resulting in force acting on the contacts 12, 16 to move at least one of the contacts (e.g., 16) away from the other contact 12 and out of the constrictive zone 20 at an end of a current interruption mode as shown in FIG. 3. Accordingly, at least one of the contacts 16 may be with-drawable from the arc constrictive zone 20 to allow the arc 32 to be dissipated. For example, the interrupter may further include an optional arc dissipation structure 34, such as a plate, ring or an array of plates forming an arc chute, to which the arc 32 is drawn from the arc constrictive zone 20.

As shown in FIG. 2, the ablative material 28 may be configured to line a wall 22 of the constrictive zone 20 around the end portions 14, 18 of the contacts 12, 16. The ablative material 28 may abut the sides 19 of the contacts 12, 16, or may be spaced away a sufficiently small clearance distance, D, to achieve a desired reduced let-through current limiting performance. For example, a desired spacing between the ablative material 28 and the sides 19 of the contacts 12, 16, or clearance distance D, may be in the range of about 0.1 mm to about 5 mm, more preferably, about 0.2 mm to about 2 mm, even more preferably, about 0.3 mm to about 1 mm, and even more preferably about 0.4 mm to about 0.7 mm. In an aspect of the invention, the ablative material 28 may include polymers such as polytetrafluoroethylene (PTFE), polyethylene, polyimide, polyamide, or poly-oxymethylene (POM), epoxide, polyester, polypropylene, poly methyl-methacralate, poly acetal, polysulphones, phenolic resin, phenolic resin composite, polyetherimide, polyether ketone, polypropylene sulphide-based polymers. Such polymers may also include organic and/or inorganic fillers and/or additives to achieve, for example, desired ablating properties. In an embodiment, the ablative material 28 may comprise a tubular insert disposed in the aperture 26.

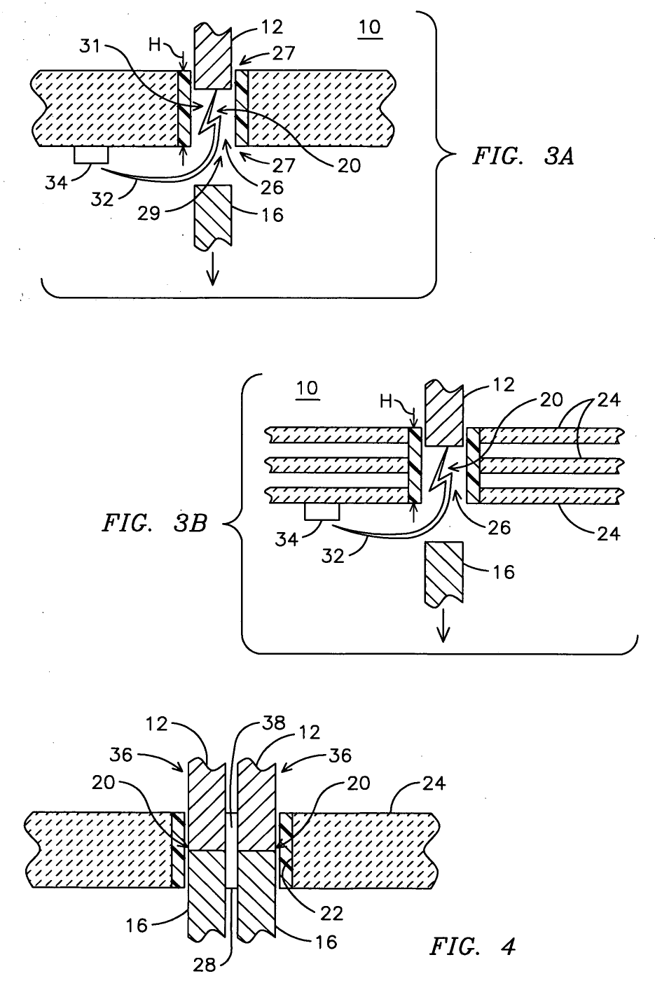

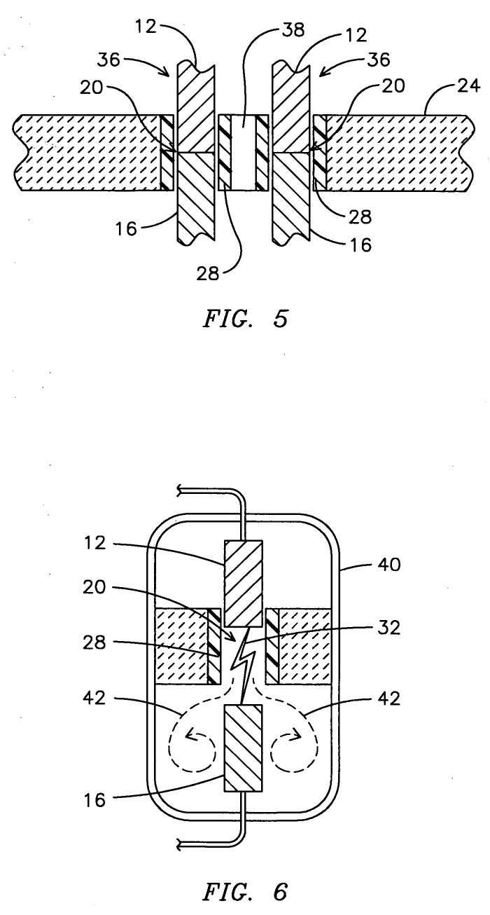

In embodiments of the invention depicted in FIGS. 4 and 5, the circuit interrupter 10 may include multiple contact pairs 36, each pair 36 comprising a first contact 12 and a second contact 16. The contacts pairs 36 may be disposed in a common constrictive zone 20 as shown in FIG. 4, the ablative material 28 forming a vapor in the constrictive zone 20 may line the wall 22 of the constrictive zone 20 and may also be disposed in spaces 38 between the contact pairs 36. In another embodiment, each contact pair 36 may be disposed in separate constrictive zones 20 as shown in FIG. 5. Each contact pair 36 may be wired in parallel or series to serve a common electrical circuit. While two contact pairs 36 are shown in FIGS. 4 and 5, it should be appreciated that two or more contact pairs 36 may be used, thereby providing two or more paths for current to flow through the interrupter 10.

The circuit interrupter 10 may be vented to a surrounding environment, or, optionally, may be disposed in an enclosure, or bottle 40, as depicted in FIG. 6. The bottle 40 may confine ablation emissions 42 generated, for example, during ablation of the ablating material 28. The bottle 40 may be filled with air or other gas such as, but not limited to, nitrogen or sulphur hexafluoride. The bottle 40 may optionally include one or more vents for venting emissions 42 from the bottle 40. In another aspect, two or more contact pairs 36, such as the contact pair configurations shown in FIGS. 4 and 5, may be housed within a bottle 40. In another example embodiment, multiple bottles 40 may be used with venting to emit cooler and/or safer emissions from the bottle(s) 40.

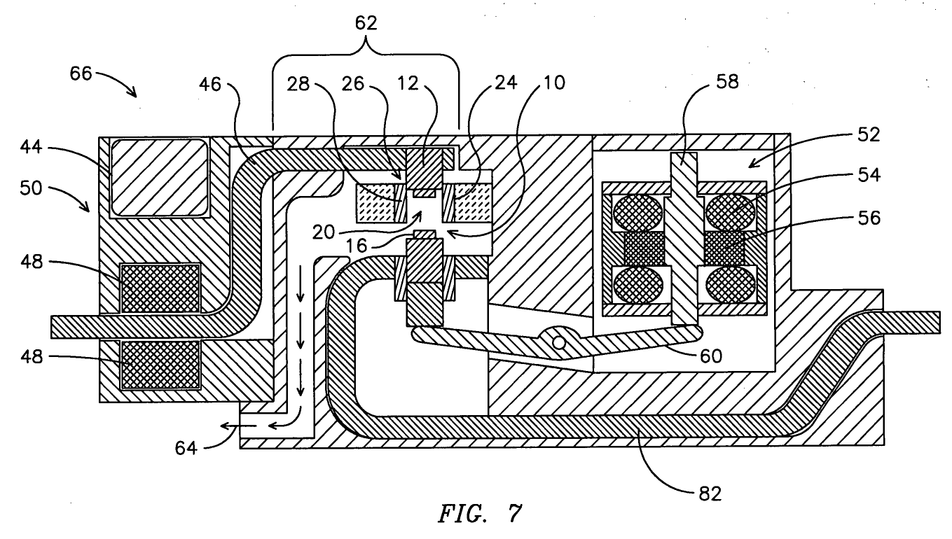

FIG. 7 shows an example circuit breaker 66, depicted in a circuit interrupting mode, including an embodiment of the circuit interrupter 10. The circuit breaker 66 includes a circuit interrupter 10 comprising a stationary contact 12 and a movable contact 16 disposed in an interruption chamber 62 of the breaker 66. The movable contact 16 is movable into and out of electrical contact with stationary contact 12, so that when the contacts 12, 16 are positioned in electrical contact, electrical power is provided to an electrical circuit via load strap 46 and line strap 82. An arc constrictive zone 20 of the circuit interrupter 10 is defined by an aperture 26 through an insulator 24, such as a ceramic plate, being lined with an ablative material 28, such as PTFE or other ablative material described previously. The insulator 24 may be formed from the polymers previously described. The movable contact 16 is moveable into and out of the zone 20 to provide improved circuit interrupting performance as described previously. A gas path 64 in communication with the interruption chamber 62 may be provided to conduct emissions generated by the ablative material 28 during a circuit interruption event out of the interruption chamber 62.

The circuit breaker 66 includes a current overload sensor 50, that may comprise a current sensing coil 48 disposed proximate the load strap 46 for sensing an electrical current level being conducted through the load strap 46. The sensor 50 may further include an electronic trip unit 44 in communication with the current sensing coil 48 for detecting an overload condition of the electrical circuit in response to a sensed load strap current level. A magnetic latch 52 in communication with the sensor 50 may be operable to provide a force on the movable contact 16 to move the contact 16 out of electrical contact with the fixed contact 12 when an overload condition is detected. The magnetic latch 52 may include coils 54 and magnets 56 for selectively moving an actuating shaft 58 to act on an interfacing lever 60 to selectively move the movable contact 16 into and out of electrical contact with the fixed contact 12. It should be understood that the above description of the circuit breaker 66 is example only, and other types of circuit breaker configurations may be used with the invention without departing form the spirit and scope of the invention. For example, a mechanical latch may be used instead of the magnetic latch 52, and the fixed contact 12 may be movable, while the movable contact 16 may be fixed fixed, or both contacts 12, 16 may be movable away from each other.

FIG. 7A shows an example three phase circuit breaker 68 including an embodiment of the circuit interrupter 10. The three phase circuit breaker 68 may include three separate circuit interrupters 10, each circuit interrupter 10 connected to a respective phase 70, 72, 74 of a three phase circuit 76. It should be understood that a multiple circuit interrupter circuit breaker embodiment is not limited to three interrupters, and may include two or more interrupters used in the circuit breaker. In an embodiment, each circuit interrupter 10 may be housed within a respective bottle 40. An activation of the circuit breaker 68 may be controlled by an arc sensing system 80, for example, sensing arcs 78 on the three phase circuit 76.

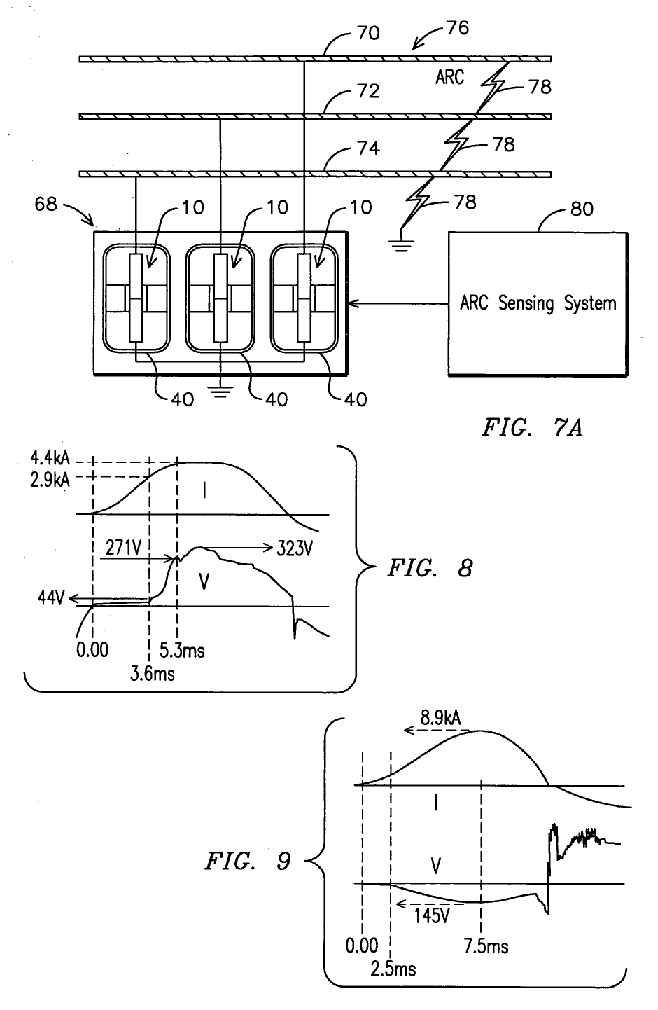

FIG. 8 shows a performance graph for an example embodiment circuit interrupter having an arc constrictive zone during a circuit interruption event for a prospective current of 10.5 kilo amps (kA). For comparison, FIG. 9 shows a performance graph of an example conventional-type circuit interrupter having no arc constrictive zone for a prospective current of 10.5 kA. As can be seen by examining the performance graphs depicted in FIGS. 8 and 9, the arc voltage develops at a much faster rate (beginning at about 3.6 milliseconds) for the circuit interrupter including an arc constrictive zone than for a circuit interrupter without an arc constrictive zone. In addition, the circuit interrupter including an arc constrictive zone displays a relatively higher arc voltage [about 323 volts (V) and allows a let through current of about 4.4 kA for about a 40% reduction from the prospective current of 10.5 kA. In contrast, the circuit interrupter having no arc constrictive zone exhibits a lower arc voltage 145 V and allows a higher let through current of 8.9 kA for only a 15% reduction of the prospective current.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

1. An apparatus for interrupting an electrical current between two contacts comprising:
a first contact;
a second contact, the first and second contacts being separable away from one another to interrupt an electrical current flowing between the contacts;
an arc constrictive zone disposed around the first and second contacts for confining an arc generated between the contacts during an initial separation of the contacts; and
an ablative material disposed in the arc constrictive zone around the first and second contacts to be ablated by the arc to form a vapor for cooling the arc and to produce an increased pressure in the restrictive zone responsive to the arc to force separation of the contacts wherein at least one of the contacts is configured to be withdrawn from the arc constrictive zone after the initial separation so that the cooled arc dissipates outside the arc constrictive zone.

2. The apparatus of claim 1, wherein the first contact is movable and the second contact is stationary.

3. The apparatus of claim 1, wherein the first contact and second contact are each movable away from one another.

4. The apparatus of claim 1, wherein the ablative material comprises a polymer selected from the group consisting of polytetrafluoroethylene (PTFE), polyethylene, polyimide, polyamide, poly-oxymethylene (POM), epaxide, polyester, polypropylene, poly-methyl methacralate, poly acetal, polysulphone, phenolic resin, phenolic resin composite, polyetherimide, polyether ketone, polypropylene sulphide based polymers.

5. The apparatus of claim 4, wherein the polymer comprises an additive selected from the group consisting of an organic filler and an inorganic filler.

6. The apparatus of claim 1, wherein a height of the constrictive zone ranges from about 1 millimeter to about 24 millimeters.

7. The apparatus of claim 1, wherein a height of the constrictive zone ranges from about 3 millimeters to about 10 millimeters.

8. The apparatus of claim 1, wherein a height of the constrictive zone ranges from about 5 millimeters to about 7 millimeters.

9. The apparatus of claim 1, wherein the constrictive zone is defined by an aperture formed in a polymer layer for receiving at least a portion of each of the contacts therein.

10. The apparatus of claim 9, wherein the ablative material lines a wall of the aperture.

11. The apparatus of claim 9, wherein a geometry of the aperture is selected to conform to a geometry of the contacts positioned therein.

12. The apparatus of claim 9, wherein a geometry of the aperture is selected from the group consisting of a circular geometry, a square geometry, a rectangular geometry, and a triangular geometry.

13. The apparatus of claim 9, wherein the ablative material comprises a tubular insert disposed in the aperture.

14. The apparatus of claim 9, wherein the aperture comprises opening portions curved away from a central region of the aperture.

15. The apparatus of claim 1, wherein the constrictive zone is defined by an aperture formed in a plurality of spaced apart polymer layers.

16. The apparatus of claim 1, further comprising a plurality of contact pairs, each pair comprising a first contact and a second contact.

17. The apparatus of claim 16, wherein the contact pairs are spaced apart from one another the ablative material extending into spaces among the spaced apart contact pairs.

18. The apparatus of claim 16, wherein the contacts pairs are disposed in respective separate constrictive zones.

19. The apparatus of claim 1, further comprising an enclosure surrounding the circuit interrupter for confining emissions generated during a circuit interruption event.

20. The apparatus of claim 19, wherein the enclosure contains a gas selected from the group consisting of sulphur hexafluoride and nitrogen.

21. The apparatus of claim 1, further comprising an arc dissipation structure receiving the arc from the constrictive zone.

22. The apparatus of claim 21, wherein the arc dissipation structure comprises an arc chute.

23. The apparatus of claim 1, wherein the ablative material abuts sides of the contacts.

24. The apparatus of claim 1, wherein the ablative material is spaced away from sides of the contacts.

25. The apparatus of claim 1, wherein a space between the ablative material and the sides of the contact ranges from about 0.1 millimeter to about 0.5 millimeter.

26. The apparatus of claim 1, wherein a space between the ablative material and the sides of the contact ranges from about 0.2 millimeter to about 2 millimeters.

27. The apparatus of claim 1, wherein a space between the ablative material and the sides of the contact ranges from about 0.3 millimeter to about 1 millimeter.

28. The apparatus of claim 1, wherein a space between the ablative material and the sides of the contact ranges from about 0.4 millimeter to about 0.7 millimeter.

29. A circuit breaker comprising a plurality of the apparatus for interrupting an electrical current of claim 1, each of the plurality of apparatus connectable to a respective different phase of a multiphase circuit for interrupting the respective different phase.

30. A circuit interrupter for capturing arc energy to provide a force for separating conducting elements during arcing between the elements the circuit interrupter comprising:
a first conducting element having a contacting end portion;
a second conducting element having a contacting end portion in electrical contact with the contacting end portion of the first conducting element for conducting an electrical current between the elements when the conducting elements are positioned in electrical contact, at least one of the first and second conducting elements movable out of electrical contact with the other element to interrupt the electrical current; and
an arc constrictive region confining an arc generated between the contacting end portions during an initial separation of the conducting elements, the region defined by an ablative material surrounding the end portions of the elements, the ablative material to be ablated during arcing between the end portions to generate a vapor for cooling the arc and to produce a pressure increase in the arc constrictive region acting to force at least one of the contacts away from the other contact, wherein at least one of the contacts is configured to be withdrawn from the arc constrictive zone after the initial separation so that the cooled arc dissipates outside the constrictive zone.

31. A method for cooling an arc and capturing arc energy to provide a force for separating contacts of a circuit interrupter during arcing between the contacts, the method comprising:
confining an arc between respective ends of separable electrical contacts of a circuit interrupter in a constrictive zone during an initial separation of the contacts from one another;
producing an arc cooling vapor responsive to the arc ablating an ablative material disposed in the constrictive zone around the contacts;
generating an increased pressure in the constrictive zone responsive to the arc ablating, the increased pressure acting to force separation of the contacts and
dissipating the arc by removing at least one of the contacts from the constrictive zone after the initial separation of the contacts from one another.

32. The method of claim 31, wherein an end of at least one contact exits the arc constriction zone during arcing.

33. The method of claim 32, dissipating the arc comprises conducting the arc from the constrictive zone to an arc dissipating structure after the end of the at least one contact exits the constrictive zone.

34. A circuit breaker for an electrical circuit comprising:
a first contact;
a second contact movable into and out of electrical contact with the first contact, the first and second contacts providing a electrical power to an electrical circuit when positioned in electrical contact with one another;
a sensor for detecting an overload condition of the electrical circuit; and
a magnetic latch in communication with the second contact for providing a first force to move the second contact out of electrical contact with the first contact;
an arc constrictive zone disposed around the first and second contacts confining an arc generated between the contacts during a an initial separation of the contacts; and
an ablative material disposed in the arc constrictive zone around the first and second contacts generating a vapor for cooling the arc and producing an increased pressure in the constrictive zone responsive to the arc, wherein at least one of the contacts is configured to be withdrawn from the arc constrictive zone after the initial separation so that the cooled arc dissipates outside the arc constrictive zone.

35. The circuit breaker of claim 34, wherein the increased pressure provides a second force to move the second contact out of electrical contact with the first contact.
